(19) United States
(12) Patent Application Publication
(10) Pub. No.: US 2013/0163122 A1
(43) Pub. Date: Jun. 27, 2013

(54) MAGNETIC HEAD HAVING HIGH-FREQUENCY OSCILLATORY ELEMENTS AND DISK DRIVE WITH THE SAME

(71) Applicant: Kabushiki Kaisha Toshiba, Tokyo (JP)

(72) Inventors: Masaya OHTAKE, Ome (JP); Tomoko TAGUCHI, Kunitachi (JP); Masayuki TAKAGISHI, Kunitachi (JP); Kenichiro YAMADA, Tokyo (JP); Katsuhiko KOUI, Yokohama (JP)

(73) Assignee: Kabushiki Kaisha Toshiba, Tokyo (JP)

(21) Appl. No.: 13/773,491

(22) Filed: Feb. 21, 2013

Related U.S. Application Data
(62) Division of application No. 13/016,687, filed on Jan. 28, 2011.

(30) Foreign Application Priority Data
Mar. 30, 2010 (JP) 2010-079074

(51) Int. Cl. G11B 5/31; G11B 5/74

(52) U.S. Cl. CPC G11B 5/31; G11B 5/743
USPC 360/235.4; 360/111

(57) ABSTRACT

According to one embodiment, a magnetic head includes a main pole configured to apply a perpendicular recording magnetic field to a recording layer of a recording medium, a return pole opposed to the trailing side of the main pole with a write gap therebetween and configured to reflux magnetic flux from the main pole to form a magnetic circuit in conjunction with the main pole, a coil configured to excite magnetic flux in the magnetic circuit includes the main pole and the return pole, a plurality of high-frequency oscillatory elements individually interposed between the main pole and the return pole, includes a plurality of magnetic films different in magnetic resonance frequency, and configured to individually apply high-frequency magnetic fields to the recording medium, and an electrical circuit configured to energize the high-frequency oscillatory elements.

### CROSS-REFERENCE TO RELATED APPLICATIONS

This application is based upon and claims the benefit of priority from Japanese Patent Application No. 2010-079074, filed Mar. 30, 2010; the entire contents of which are incorporated herein by reference.

### FIELD

Embodiments described herein relate generally to a magnetic head for perpendicular magnetic recording used in a disk drive and the disk drive provided with the head.

### BACKGROUND

A disk drive, such as a magnetic disk drive, comprises a magnetic disk, spindle motor, magnetic head, and carriage assembly. The magnetic disk is disposed in a base. The spindle motor supports and rotates the disk. The magnetic head reads and writes data from and to the disk. The carriage assembly supports the head for movement relative to the disk. The carriage assembly comprises a pivotably supported arm and a suspension extending from the arm, and the magnetic head is supported on an extended end of the suspension. The head comprises a slider mounted on the suspension and a head section disposed on the slider. The head section comprises a recording element for writing and a reproduction element for reading.

Magnetic heads for perpendicular magnetic recording have recently been proposed in order to increase the recording density and capacity of a magnetic disk drive or reduce its size. In one such magnetic head, a recording head comprises a main pole configured to produce a perpendicular magnetic field, return or write/shield pole, and coil. The return pole is located on the trailing side of the main pole with a write gap therebetween and configured to close a magnetic path that leads to a magnetic disk. The coil serves to pass magnetic flux through the main pole.

In order to improve the recording density, a high-frequency magnetic field assisted recording head is proposed, in which high-frequency oscillatory elements are interposed between main and return poles and high-frequency magnetic fields from the oscillatory elements are applied to a magnetic recording layer.

Even in the magnetic head constructed in this manner, however, write margins for a recording area may be insufficient. If the recording density is increased, therefore, adjacent recording areas may be subjected to magnetization reversal, thereby causing a write error.

### BRIEF DESCRIPTION OF THE DRAWINGS

A general architecture that implements the various feature of the embodiments will now be described with reference to the drawings. The drawings and the associated descriptions are provided to illustrate the embodiments and not to limit the scope of the invention.

FIG. 1 is an exemplary perspective view showing a hard disk drive (HDD) according to a first embodiment;

FIG. 2 is an exemplary side view showing a magnetic head and suspension of the HDD;

FIG. 3 is an exemplary enlarged sectional view showing a head section of the magnetic head;

FIG. 4 is an exemplary perspective view schematically showing a recording head of the magnetic head;

FIG. 5 is an exemplary sectional view of a magnetic disk used in the HDD;

FIG. 6 is an exemplary plan view showing a recording layer of the magnetic disk;

FIG. 7 is an exemplary enlarged sectional view showing the magnetic disk and a disk-side end portion of the magnetic head;

FIG. 8 is an exemplary plan view of the recording head section taken from the side of an ABS of a slider;

FIG. 9A is an exemplary diagram showing an initial dot state of the magnetic disk before the recording head is run;

FIG. 9B is an exemplary diagram showing current gates through which a recording current is passed to the recording head;

FIG. 9C is an exemplary diagram schematically showing a recording operation performed by the recording head;

FIG. 9D is an exemplary diagram showing how the magnetization of magnetic dots of the magnetic disk is reversed;

FIG. 9E is an exemplary diagram showing current gates through which a recording current is passed to the recording head;

FIG. 9F is an exemplary diagram schematically showing the recording operation performed by the recording head;

FIG. 9G is an exemplary diagram showing how the magnetization of the magnetic dots of the magnetic disk is reversed;

FIG. 10 is an exemplary diagram comparatively showing the relationships between the linear recording density and bit error rate for a magnetic head according to a comparative example and the magnetic head according to the present embodiment;

FIG. 11 is an exemplary perspective view schematically showing a recording head of a magnetic head of an HDD according to a second embodiment;

FIG. 12 is an exemplary plan view of the recording head of the second embodiment taken from the side of an ABS;

FIG. 13 is an exemplary perspective view schematically showing a recording head of a magnetic head of an HDD according to a third embodiment;

FIG. 14 is an exemplary plan view of the recording head of the third embodiment taken from the side of an ABS;

FIG. 15 is an exemplary perspective view schematically showing a recording layer of a magnetic head of an HDD according to a fourth embodiment;

FIG. 16 is an exemplary plan view schematically showing the recording layer of the magnetic head of the HDD of the fourth embodiment;

FIG. 17 is an exemplary perspective view schematically showing a recording layer of a magnetic head of an HDD according to a fifth embodiment;

FIG. 18 is an exemplary plan view schematically showing the recording layer of the magnetic head of the HDD of the fifth embodiment;

FIG. 19 is an exemplary perspective view schematically showing a recording layer of a magnetic head of an HDD according to a sixth embodiment;

FIG. 20 is an exemplary plan view schematically showing the recording layer and a recording head of the magnetic head of the HDD of the sixth embodiment; and

FIG. 21 is an exemplary plan view schematically showing the recording layer and recording head of the magnetic head of the HDD of the sixth embodiment.

### DETAILED DESCRIPTION

Various embodiments will be described hereinafter with reference to the accompanying drawings.

In general, according to one embodiment, a magnetic head comprises a main pole configured to apply a perpendicular recording magnetic field to a recording layer of a recording medium; a return pole opposed to the trailing side of the main pole with a write gap therebetween and configured to reflux magnetic flux from the main pole to form a magnetic circuit in conjunction with the main pole; a coil configured to excite magnetic flux in the magnetic circuit comprising the main pole and the return pole; a plurality of high-frequency oscillatory elements individually interposed between the main pole and the return pole, comprising a plurality of magnetic films different in magnetic resonance frequency, and configured to individually apply high-frequency magnetic fields to the recording medium; and an electrical circuit configured to energize the high-frequency oscillatory elements.

A hard disk drive (HDD) as a disk drive according to a first embodiment will now be described in detail.

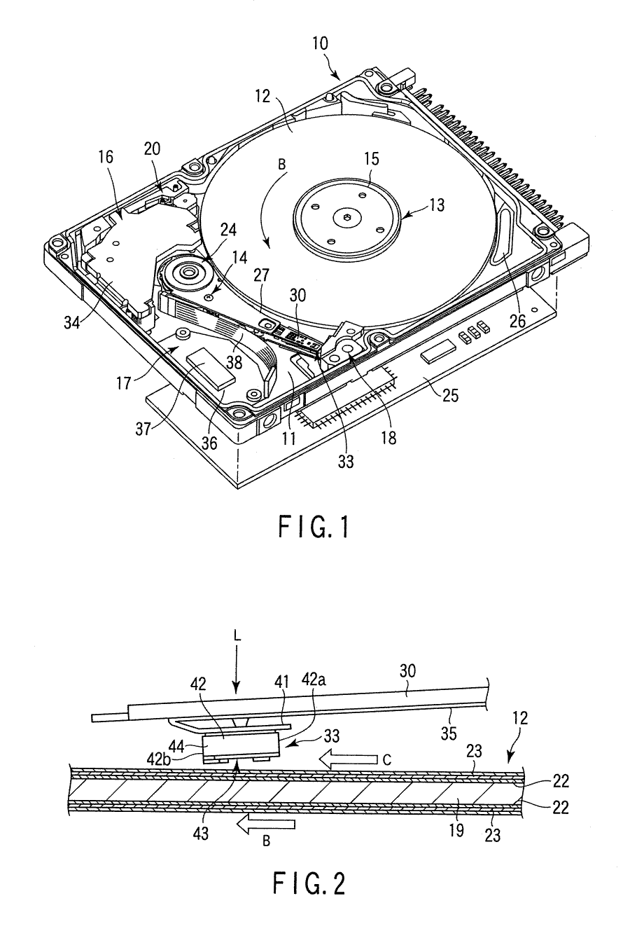

FIG. 1 shows the internal structure of the HDD with its top cover off, and FIG. 2 shows a flying magnetic head. As shown in FIG. 1, the HDD comprises a case 10, which comprises a base 11 in the form of an open-topped rectangular box and a top cover (not shown) in the form of a rectangular plate. The top cover is attached to the base by screws so as to close the top opening of the base. Thus, the case 10 is kept airtight inside and can communicate with the outside through a breathing filter 26 only. The base 11 and the top cover are formed of a metallic material such as aluminum, iron, stainless steel, or cold-rolled carbon steel.

The base 11 carries thereon a magnetic disk 12, for use as a recording medium, and a mechanical unit. The mechanical unit comprises a spindle motor 13, a plurality (e.g., two) of magnetic heads 33, head actuator 14, and voice coil motor (VCM) 16. The spindle motor 13 supports and rotates the magnetic disk 12. The magnetic heads 33 record and reproduce data in and from the disk 12. The head actuator 14 supports the heads 33 for movement relative to the disk 12. The VCM 16 pivots and positions the head actuator. The base 11 further carries a ramp load mechanism 18, inertial latch mechanism 20, and board unit 17. The ramp load mechanism 18 holds the magnetic heads 33 in positions off the magnetic disk 12 when the heads are moved to the outermost periphery of the disk. The inertial latch mechanism 20 holds the head actuator 14 in a retracted position if the HDD is jolted, for example. Electronic components, such as a preamplifier, head IC, etc., are mounted on the board unit 17.

A printed circuit board 25 is attached to the outer surface of a bottom wall of the base 11 by screws so as to face the bottom wall of the base. The circuit board 25 controls the operations of the spindle motor 13, VCM 16, and magnetic heads 33 through the board unit 17.

As shown in FIG. 1, the magnetic disk 12 is coaxially fitted on the hub of the spindle motor 13 and clamped and secured to the hub by a clamp spring 15, which is attached to the upper end of the hub by screws. The disk 12 is rotated at a predetermined speed in the direction of arrow B by the spindle motor 13.

The head actuator 14 comprises a bearing 24 secured to the bottom wall of the base 11 and a plurality of arms 27 extending from the bearing. The arms 27 are arranged parallel to the surfaces of the magnetic disk 12 and at predetermined intervals and extend in the same direction from the bearing 24. The head actuator 14 comprises elastically deformable suspensions 30 each in the form of an elongated plate. Each suspension 30 is formed of a plate spring, the proximal end of which is secured to the distal end of its corresponding arm 27 by spot welding or adhesive bonding and which extends from the arm. Each suspension 30 may be formed integrally with its corresponding arm 27. The magnetic heads 33 are supported individually on the respective extended ends of the suspensions 30. Each arm 27 and its corresponding suspension 30 constitute a head suspension, and the head suspension and each magnetic head 33 constitute a head suspension assembly.

As shown in FIG. 2, each magnetic head 33 comprises a substantially cuboid slider 42 and read/write head section 44 on an outflow end (trailing end) of the slider. Each head 33 is secured to a gimbal spring 41 on the distal end portion of each corresponding suspension 30. A head load L directed to the surface of the magnetic disk 12 is applied to each head 33 by the elasticity of the suspension 30. The two arms 27 are arranged parallel to and spaced apart from each other, and the suspensions 30 and heads 33 mounted on these arms face one another with the magnetic disk 12 between them.

Each magnetic head 33 is electrically connected to a main flexible printed circuit board (main FPC, described later) 38 through the suspension 30 and a relay FPC 35 on the arm 27.

As shown in FIG. 1, the board unit 17 comprises an FPC main body 36 formed of a flexible printed circuit board and the main FPC 38 extending from the FPC main body. The FPC main body 36 is secured to the bottom surface of the base 11. The electronic components, including a preamplifier 37 and head IC, are mounted on the FPC main body 36. An extended end of the main FPC 38 is connected to the head actuator 14 and also connected to each magnetic head 33 through each relay FPC 35.

The VCM 16 comprises a support frame (not shown) extending from the bearing 24 in the direction opposite to the arms 27 and a voice coil supported on the support frame. When the head actuator 14 is assembled to the base 11, the voice coil is located between a pair of yokes 34 that are secured to the base 11. Thus, the voice coil, along with the yokes and a magnet secured to the yokes, constitutes the VCM 16.

If the voice coil of the VCM 16 is energized with the magnetic disk 12 rotating, the head actuator 14 pivots, whereupon each magnetic head 33 is moved to and positioned on a desired track of the magnetic disk 12. As this is done, the head 33 is moved radially relative to the disk 12 between the inner and outer peripheral edges of the disk.

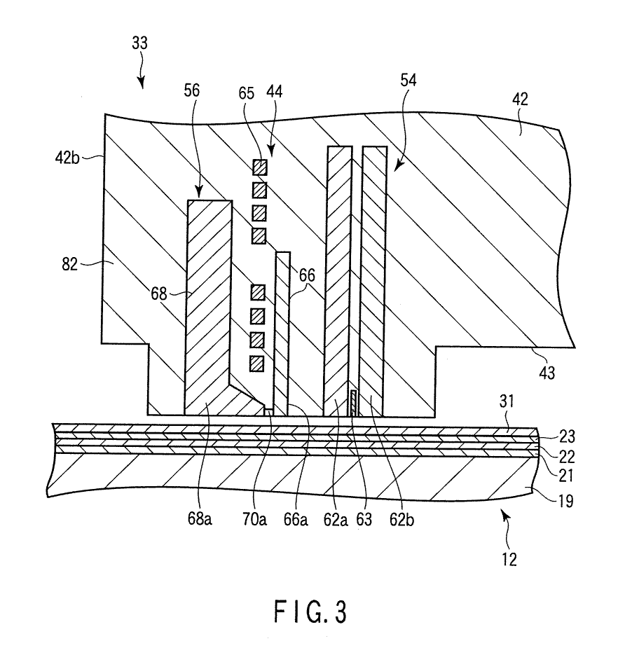

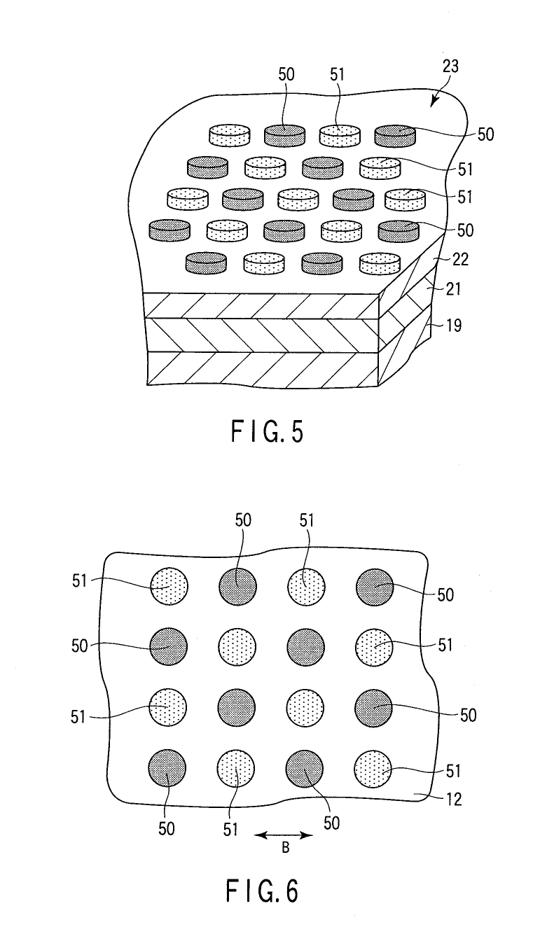

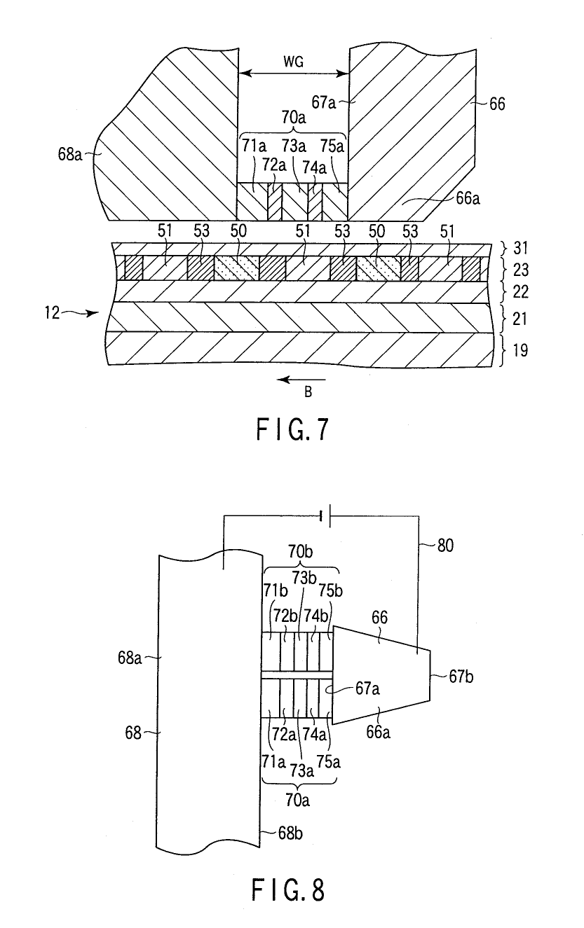

The following is a detailed description of configurations of the magnetic disk 12 and each magnetic head 33. FIG. 3 is an exemplary enlarged sectional view showing the head section 44 of the head 33. FIGS. 5 and 6 are exemplary perspective and plan views, respectively, schematically showing a recording layer of the magnetic disk 12. FIG. 7 is an exemplary enlarged sectional view showing the magnetic disk and a disk-side end portion of the magnetic head.

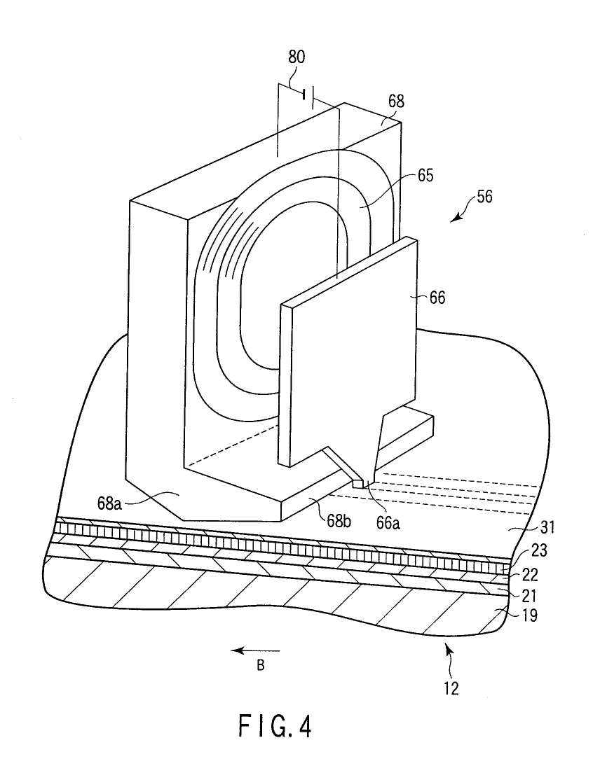

As shown in FIGS. 1 and 2, the magnetic disk 12 comprises a substrate 19 formed of a nonmagnetic disk with a diameter of, for example, about 2.5 inches. As shown in FIGS. 2 to 4, a soft magnetic layer 21 for use as an underlayer is formed on each surface of the substrate 19. The soft magnetic layer 21 is overlain by a nonmagnetic layer 22 for orientation control and a magnetic recording layer 23 having a magnetic anisotropy perpendicular to the disk surface. Further, a protective layer 31 is formed as an outermost layer on the recording layer 23.

As shown in FIGS. 5, 6 and 7, the magnetic recording layer 23 comprises a plurality of magnetic dots 50 and 51 formed of a plurality (e.g., two) of types of ferromagnetic materials, which have different magnetic resonance frequencies and are magnetically separated, and a nonmagnetic material 53 that fills the space between the separated dots 50 and 51. The two types of dots 50 and 51 with different resonance frequencies are alternately arranged along the circumference of the magnetic disk 12, that is, in a direction of rotation B of the disk. The dots 50 and 51 are also alternately arranged in the radial direction of the disk 12.

As shown in FIGS. 2 and 3, each magnetic head 33 is formed as a flying head, and comprises the substantially cuboid slider 42 and the head section 44 formed on the outflow or trailing end of the slider. The slider 42 is formed of, for example, a sintered body (AlTic) containing alumina and titanium carbide, and the head section 44 is a thin film.

The slider 42 has a rectangular disk-facing surface or air-bearing surface (ABS) 43 configured to face a surface of the magnetic disk 12. The slider 42 is caused to fly by airflow C that is produced between the disk surface and ABS 43 as the magnetic disk 12 rotates. The direction of airflow C is coincident with the direction of rotation B of the disk 12. The slider 42 is located on the surface of the disk 12 in such a manner that the longitudinal direction of the ABS 43 is substantially coincident with the direction of airflow C.

The slider 42 comprises leading and trailing ends 42a and 42b on the inflow and outflow sides, respectively, of airflow C. The ABS 43 of the slider 42 is formed with leading and trailing steps, side steps, negative-pressure cavity, etc., which are not shown.

As shown in FIG. 3, the head section 44 is formed as a dual-element magnetic head, comprising a reproduction head 54 and recording head 56 formed on the trailing end 42b of the slider 42 by thin-film processing.

The reproduction head 54 comprises a magnetic film 63 having a magnetoresistive effect and shield films 62a and 62b located on the trailing and leading sides, respectively, of the magnetic film 63 so as to sandwich the magnetic film between them. The respective lower ends of the magnetic film 63 and shield films 62a and 62b are exposed in the ABS 43 of the slider 42.

The recording head 56 is located nearer to the trailing end 42b of the slider 42 than the reproduction head 54. The recording head 56 is formed as a single-pole head comprising a return pole on its trailing end side.

FIG. 8 is an exemplary deployment diagram of a recording head section taken from the side of the ABS 43 of the slider 42. As shown in FIGS. 3, 4, 7 and 8, the recording head 56 comprises a main pole 66, return pole (write/shield electrode) 68, and recording coil 65. The main pole 66 is formed of a high-permeability material and produces a recording magnetic field perpendicular to the surfaces of the magnetic disk 12. The return pole 68 is located on the trailing side of the main pole 66 and serves to efficiently close a magnetic path through the soft magnetic layer 21 just below the main pole. The recording coil 65 is located so as to wind around a magnetic path including the main and return poles 66 and 68 to pass magnetic flux to the main pole 66 while a signal is being written to the magnetic disk 12.

The main pole 66 extends substantially at right angles to the surfaces of the magnetic disk 12. A distal end portion 66a of the main pole 66 on the side of the magnetic disk 12 is tapered toward the disk surface. As shown in FIG. 8, the distal end portion 66a of the main pole 66 is formed with, for example, a trapezoidal cross-section and comprises a trailing end face 67a and leading end face 67b. The trailing end face 67a has a predetermined width and is located on the trailing end side. The leading end face 67b, which is narrower than the trailing end face 67a, is opposed to it. The distal end face of the main pole 66 is exposed in the ABS 43 of the slider 42.

The return pole 68 is substantially L-shaped and its distal end portion 68a has an elongated rectangular shape. The distal end face of the return pole 68 is exposed in the ABS 43 of the slider 42. A leading end face 68b of the distal end portion 68a extends transversely relative to the track of the magnetic disk 12. The leading end face 68b is opposed parallel to the trailing end face 67a of the main pole 66 with a write gap WG therebetween.

As shown in FIGS. 7 and 8, the recording head 56 comprises a plurality (e.g., two) of spin-torque oscillators 70a and 70b interposed between the respective opposite surfaces of the return pole 68 and the distal end portion 66a of the main pole 66. The spin-torque oscillators 70a and 70b for use as high-frequency oscillatory elements are arranged substantially parallel to and magnetically separated from one another transversely relative to the track between the trailing end face 67a of the distal end portion 66a of the main pole 66 and the leading end face 68b of the return pole 68.

Spin-torque oscillator 70a comprises a nonmagnetic layer 71a, oscillatory layer 72a, intermediate layer 73a, spin injection layer 74a, and nonmagnetic layer 75a, which are sequentially laminated from the side of the return pole 68 toward the main pole 66. Likewise, spin-torque oscillator 70b comprises a nonmagnetic layer 71b, oscillatory layer 72b, intermediate layer 73b, spin injection layer 74b, and nonmagnetic layer 75b, which are sequentially laminated from the side of the return pole 68 toward the main pole 66. The respective oscillatory layers 72a and 72b of the spin-torque oscillators 70a and 70b differ in magnetic resonance frequency. The resonance frequency of oscillatory layer 72a of spin-torque oscillator 70a is adjusted to that of the magnetic dots 50 of the magnetic disk 12. Further, the resonance frequency of oscillatory layer 72b of spin-torque oscillator 70b is adjusted to that of the magnetic dots 51 of the magnetic disk.

The two oscillatory layers 72a and 72b with the different resonance frequencies may be formed of either different ferromagnetic materials or members of the same ferromagnetic material in different volumes. Further, the order of lamination of the layers 71a, 71b, 72a, 72b, 73a, 73b, 74a, 74b, 75a and 75b may be opposite to the running direction of each magnetic head 33.

The respective distal ends of the spin-torque oscillators 70a and 70b are exposed in the ABS 43 so as to be flush with the distal end face of the main pole 66 with respect to the surface of the magnetic disk 12. The oscillators 70a and 70b are controlled by an electrical circuit 80, which is connected between the main pole 66 and return pole 68, and apply a high-frequency magnetic field to the magnetic disk 12.

As shown in FIG. 3, a protective insulating film 82 entirely covers the reproduction head 54 and recording head 56 except for those parts which are exposed in the ABS 43 of the slider 42. The protective insulating film 82 defines the contour of the head section 44.

When the VCM 16 is activated, according to the HDD constructed in this manner, the head actuator 14 pivots, whereupon each magnetic head 33 is moved to and positioned on the desired track of the magnetic disk 12. Further, the magnetic head 33 is caused to fly by airflow C that is produced between the disk surface and the ABS 43 as the magnetic disk 12 rotates. When the HDD is operating, the ABS 43 of the slider 42 is opposed to the disk surface with a gap therebetween. As shown in FIG. 2, the magnetic head 33 is caused to fly with the recording head 56 of the head section 44 inclined to be closest to the surface of the disk 12. In this state, the reproduction head 54 reads recorded data from the disk 12, while the recording head 56 writes data to the disk.

In writing data, a direct current is supplied from the electrical circuit 80 to the spin-torque oscillators 70a and 70b to produce a high-frequency magnetic field, which is applied to the magnetic recording layer 23 of magnetic disk 12. Further, the main pole 66 is excited by the recording coil 65 so that a perpendicular recording magnetic field is applied from the main pole to the recording layer 23 of the disk 12 just below the main pole, whereby data with a desired track width is recorded. Magnetic recording can be achieved with a high coercive force and high magnetic anisotropic energy by superposing the high-frequency magnetic field on the recording magnetic field.

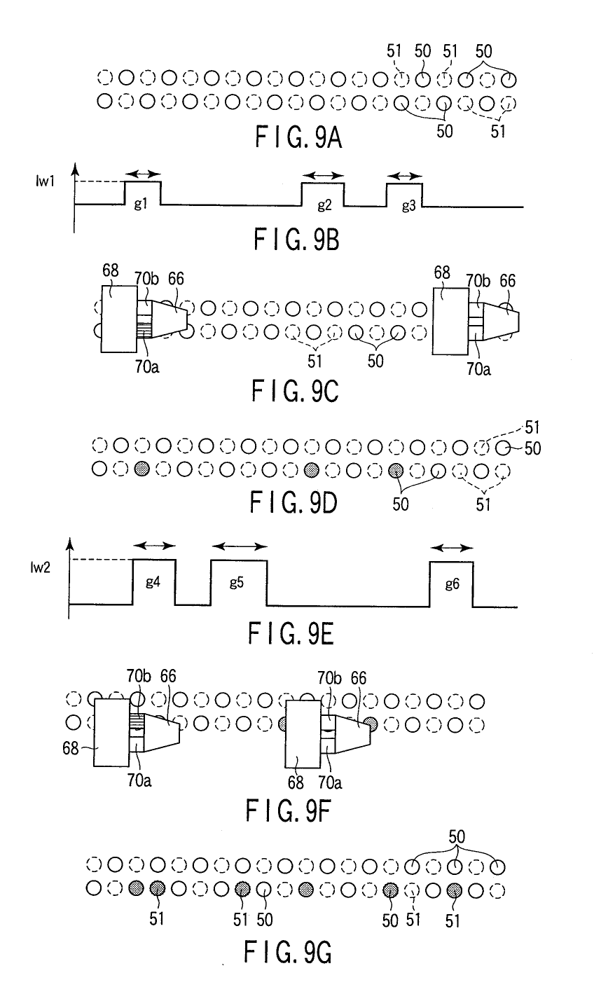

A recording operation of the recording head 56 of the HDD of the present embodiment will now be described with reference to FIGS. 9A to 9G. FIG. 9A shows an initial dot state of the magnetic disk 12 before the recording head 56 is run. For example, the magnetic dots 50 and 51 are magnetized substantially perpendicularly downward relative to the surface of the recording layer 23. FIG. 9B is a current gate diagram showing how a current Iw1 for oscillating spin-torque oscillator 70a is passed through the electrical circuit 80 at recording gates g1, g2 and g3, and at the same time, a recording current is passed through the recording coil 65. In this case, the recording head 56 is positioned relative to the magnetic disk 12 so that spin-torque oscillator 70a faces a desired track, as shown in FIG. 9C. Thereafter, a high-frequency magnetic field is generated by spin-torque oscillator 70a of the recording head 56. This high-frequency magnetic field reverses the magnetization of the magnetic dots 50 that have the same resonance frequency as spin-torque oscillator 70a, as shown in FIG. 9D. Since the magnetic dots 51 do not resonate even if the recording gate timing covers the adjacent dots 51, magnetization reversal does not occur. Thus, a desired signal is written to only the magnetic dots 50 of the magnetic disk 12 by the recording head 56.

FIG. 9E is a current gate diagram showing how a current Iw2 for oscillating spin-torque oscillator 70b is passed through the electrical circuit 80 at recording gates g4, g5 and g6, and at the same time, a recording current is passed through the recording coil 65. After the recording head 56 is positioned relative to the magnetic disk 12 so that spin-torque oscillator 70b faces a desired track, as shown in FIG. 9F, a high-frequency magnetic field is generated by spin-torque oscillator 70b of the recording head 56. This high-frequency magnetic field reverses the magnetization of the magnetic dots 51 that have the same resonance frequency as spin-torque oscillator 70b, as shown in FIG. 9G. Since the magnetic dots 50 do not resonate even if the recording gate timing covers the adjacent dots 50, magnetization reversal does not occur. Thus, a desired signal is written to only the magnetic dots 51 of the magnetic disk 12 by the recording head 56.

Conventionally, a write margin or range in which a current can be passed is allowed for only one magnetic dot. In the magnetic head 33 of the present embodiment, however, write margins can be allowed for magnetic dots as many as the spin-torque oscillators. Specifically, according to the present embodiment, write margins can be secured for two adjacent magnetic dots 50 and 51. Thus, erasure of the adjacent magnetic dots can be prevented while maintaining the recording capacity on a write track, and the linear recording density of the magnetic disk 12 can be improved.

The inventor hereof prepared the magnetic head 33 according to the present embodiment and a magnetic head according to a comparative example and compared their respective bit error rates obtained during recording and reproduction operations using them. It is assumed that the comparative example is a magnetic head comprising a single spin-torque oscillator and that its recording layer is formed of an ferromagnetic material with a single magnetic resonance frequency.

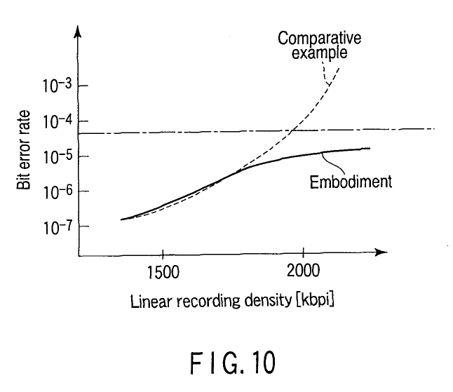

FIG. 10 shows results of evaluation on the relationships between the linear recording density and bit error rate for the present embodiment and comparative example. If the linear recording density is low, the bit error rate of the magnetic head of the comparative example is substantially the same as that of the present embodiment. If the linear recording density is increased so that the bit length is reduced, however, bit errors become liable to occur, thereby suddenly degrading the error rate, as seen from FIG. 10. For the magnetic head of the HDD according to the present embodiment, it is indicated that occurrence of bit errors is suppressed even in high-linear-density recording and the degraded error rate is improved.

The following is a description of magnetic heads of HDDs according to alternative embodiments.

In the description of the alternative embodiments to follow, like reference numbers are used to designate the same portions as those of the first embodiment, and a detailed description thereof is omitted.

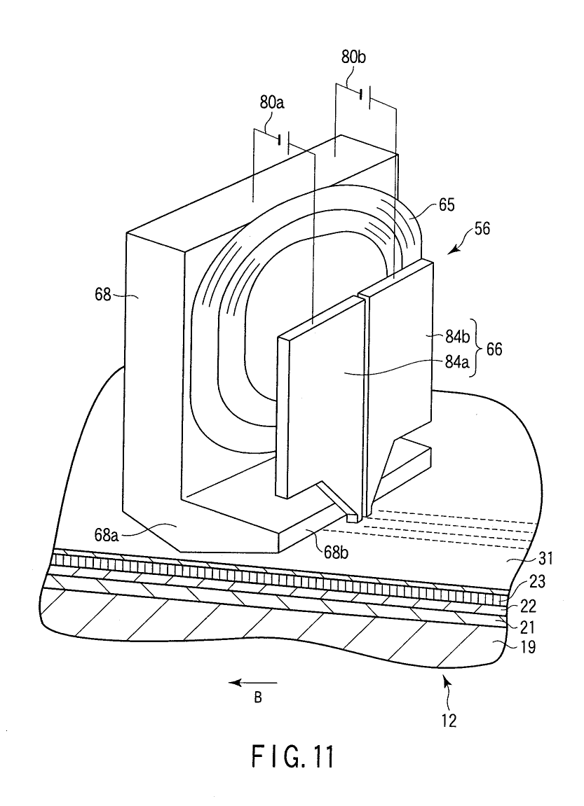

FIG. 11 is an exemplary perspective view schematically showing a recording head 56 of a magnetic head of an HDD according to a second embodiment, and

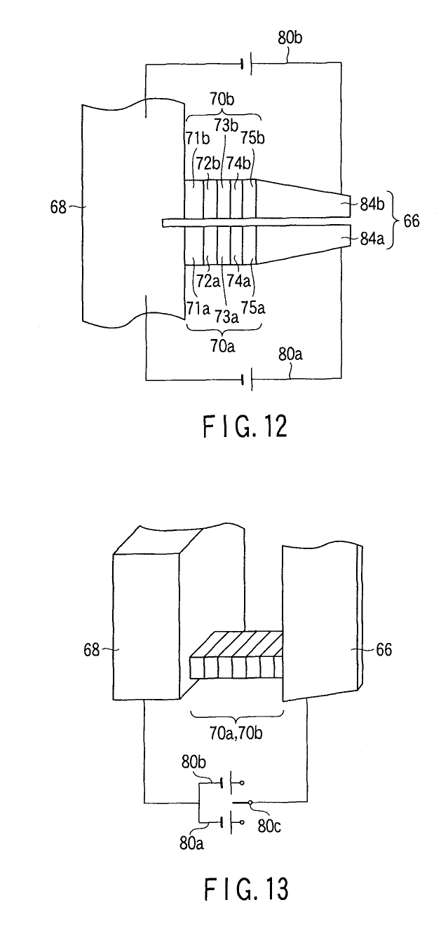

FIG. 12 is an exemplary plan view of the recording head taken from the side of an ABS of a slider.

According to the second embodiment, as shown in FIGS. 11 and 12, a main pole 66 of the recording head 56 comprises two main poles (first and second main poles) 84a and 84b formed of a high-permeability material and magnetically separated transversely relative to the track. As a whole, the distal end portion of the main pole 66 is tapered toward a surface of a magnetic disk. The distal end portion of each main pole is formed with, for example, a trapezoidal cross-section and comprises trailing and leading end faces. The trailing end face has a predetermined width and is located on the trailing end side. The leading end face, which is narrower than the trailing end face, is opposed to it. The respective distal end faces of the main poles 84a and 84b are exposed in an ABS 43 of a slider 42.

The recording head 56 comprises a return pole 68 and recording coil 65. The return pole 68 is located on the trailing side of the main poles 84a and 84b and serves to efficiently close a magnetic path through a soft magnetic layer 21 just below the main poles. The recording coil 65 is located so as to wind around a magnetic path including the main poles 84a and 84b and return pole 68 to pass magnetic flux to the main poles while a signal is being written to a magnetic disk 12.

The return pole 68 is substantially L-shaped and its distal end portion 68a has an elongated rectangular shape. The distal end face of the return pole 68 is exposed in the ABS 43 of the slider 42. A leading end face 68b of the distal end portion 68a extends transversely relative to the track of the magnetic disk 12. The leading end face 68b is opposed parallel to the respective trailing end faces of the main poles 84a and 84b with a write gap WG therebetween.

The recording head 56 comprises spin-torque oscillators 70a and 70b. Spin-torque oscillator 70a is interposed between the respective opposite surfaces of the return pole 68 and the distal end portion of main pole 84a. Spin-torque oscillator 70b is interposed between the respective opposite surfaces of the return pole 68 and the distal end portion of main pole 84b. The spin-torque oscillators 70a and 70b for use as high-frequency oscillatory elements are arranged substantially parallel to and magnetically separated from one another transversely relative to the track between the main pole 66 and return pole 68.

Spin-torque oscillator 70a comprises a nonmagnetic layer 71a, oscillatory layer 72a, intermediate layer 73a, spin injection layer 74a, and nonmagnetic layer 75a, which are sequentially laminated from the side of the return pole 68 toward main pole 84a. Likewise, spin-torque oscillator 70b comprises a nonmagnetic layer 71b, oscillatory layer 72b, intermediate layer 73b, spin injection layer 74b, and nonmagnetic layer 75b, which are sequentially laminated from the side of the return pole 68 toward main pole 84b. The respective oscillatory layers 72a and 72b of the spin-torque oscillators 70a and 70b differ in magnetic resonance frequency. The resonance frequency of oscillatory layer 72a of oscillator 70a is adjusted to that of magnetic dots 50 of the magnetic disk 12. The resonance frequency of oscillatory layer 72b of oscillator 70b is adjusted to that of magnetic dots 51 of the magnetic disk.

The two oscillatory layers 72a and 72b with the different resonance frequencies may be formed of either different ferromagnetic materials or members of the same ferromagnetic material in different volumes. Further, the order of lamination of the layers 71a, 71b, 72a, 72b, 73a, 73b, 74a, 74b, 75a and 75b may be opposite to the running direction of each magnetic head 33.

The respective distal ends of the spin-torque oscillators 70a and 70b are exposed in the ABS 43 so as to be flush with the distal end face of the main pole 66 with respect to the surface of the magnetic disk 12. The magnetic head 33 comprises electrical circuits 80a and 80b. Electrical circuit 80a is configured to pass a current to main pole 84a, spin-torque oscillator 70a, and return pole 68. Electrical circuit 80b is configured to pass a current to main pole 84b, spin-torque oscillator 70b, and return pole 68. Spin-torque oscillator 70a is controlled by electrical circuit 80a and is configured to apply a high-frequency magnetic field to the magnetic disk 12 when supplied with the current. Spin-torque oscillator 70b is controlled by electrical circuit 80b and is configured to apply a high-frequency magnetic field to the disk 12 when supplied with the current.

Also in the second embodiment arranged in this manner, there may be provided a magnetic head, configured so that the linear recording density can be increased by improving write margins, and a disk drive provided with the same. Further, drive currents can be separately supplied from the independent electrical circuits 80a and 80b to the spin-torque oscillators 70a and 70b, so that the spin-torque oscillators can be separately oscillated with additional reliability.

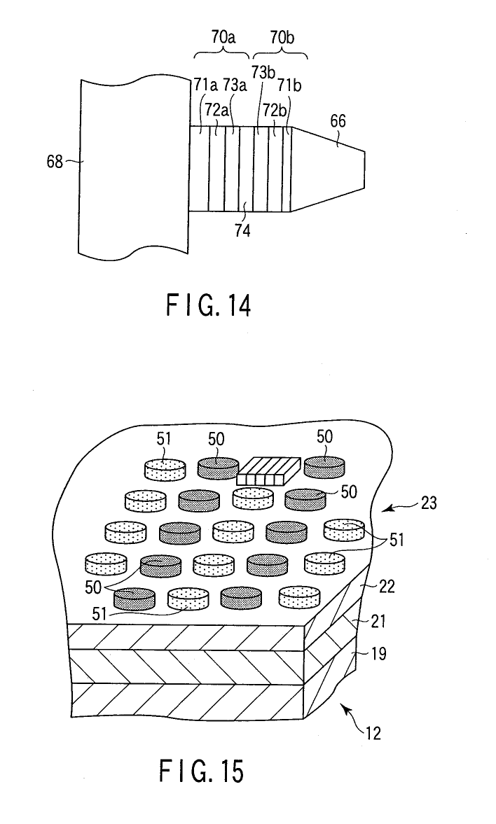

FIG. 13 is an exemplary perspective view schematically showing a recording head 56 of a magnetic head of an HDD according to a third embodiment, and FIG. 14 is an exemplary plan view of the recording head taken from the side of an ABS of a slider.

According to the third embodiment, as shown in FIGS. 13 and 14, the recording head 56 comprises a main pole 66 of a high-permeability material, the distal end of which is tapered toward a surface of a magnetic disk. The distal end portion of the main pole 66 is formed with, for example, a trapezoidal cross-section and comprises trailing and leading end faces. The trailing end face has a predetermined width and is located on the trailing end side. The leading end face, which is narrower than the trailing end face, is opposed to it. The distal end face of the main pole 66 is exposed in an ABS 43 of a slider 42.

The recording head 56 comprises a return pole 68 and recording coil. The return pole 68 is located on the trailing side of the main pole 66 and serves to efficiently close a magnetic path through a soft magnetic layer 21 just below the main pole. The recording coil is located so as to wind around a magnetic path including the main pole 66 and return pole 68 to pass magnetic flux to the main pole while a signal is being written to a magnetic disk 12.

The recording head 56 comprises a plurality (e.g., two) of spin-torque oscillators 70a and 70b interposed between the respective opposite surfaces of the return pole 68 and the distal end portion of the main pole 66. The spin-torque oscillators 70a and 70b for use as high-frequency oscillatory elements are arranged in lines along the track between the distal end portion of the main pole 66 and the leading end face of the return pole 68.

Spin-torque oscillator 70a comprises a nonmagnetic layer 71a, oscillatory layer 72a, intermediate layer 73a, and spin injection layer 74, which are sequentially laminated from the side of the return pole 68 toward the main pole 66. Spin-torque oscillator 70b comprises a nonmagnetic layer 71b, oscillatory layer 72b, intermediate layer 73b, and spin injection layer 74, which are sequentially laminated from the side of the main pole 66 toward the return pole 68. The spin injection layer 74 is shared by the oscillators 70a and 70b. The resonance frequency of oscillatory layer 72a of oscillator 70a is adjusted to that of magnetic dots 50 of the magnetic disk 12. The resonance frequency of oscillatory layer 72b of oscillator 70b is adjusted to that of magnetic dots 51 of the magnetic disk.

The two oscillatory layers 72a and 72b with the different resonance frequencies may be formed of either different ferromagnetic materials or members of the same ferromagnetic material in different volumes. Further, the order of lamination of the layers 71a, 71b, 72a, 72b, 73a, 73b, 74, 75a and 75b may be opposite to the running direction of each magnetic head 33.

The respective distal ends of the spin-torque oscillators 70a and 70b are exposed in the ABS 43 so as to be flush with the distal end face of the main pole 66 with respect to the surface of the magnetic disk 12. The magnetic head 33 comprises electrical circuits 80a and 80b and a switch 80c for changing these electrical circuits. Electrical circuit 80a is configured to pass a current to the main pole 66, spin-torque oscillator 70a, and return pole 68. Electrical circuit 80b is configured to pass a current to the main pole 66, spin-torque oscillator 70b, and return pole 68. Spin-torque oscillator 70a is controlled by electrical circuit 80a and is configured to apply a high-frequency magnetic field to the magnetic disk 12 when supplied with the current. Spin-torque oscillator 70b is controlled by electrical circuit 80b and is configured to apply a high-frequency magnetic field to the disk 12 when supplied with the current.

Also in the third embodiment arranged in this manner, there may be provided a magnetic head, configured so that the linear recording density can be increased by improving write margins, and a disk drive provided with the same. Further, the spin injection layer can be used in common for the spin-torque oscillators 70a and 70b, so that the structure can be simplified. Since the spin-torque oscillators 70a and 70b are arranged along the track, data can be sequentially written to the magnetic dots 50 and 51 with the magnetic head positioned above a common track during a recording operation. Thus, positioning control of the magnetic head can be simplified.

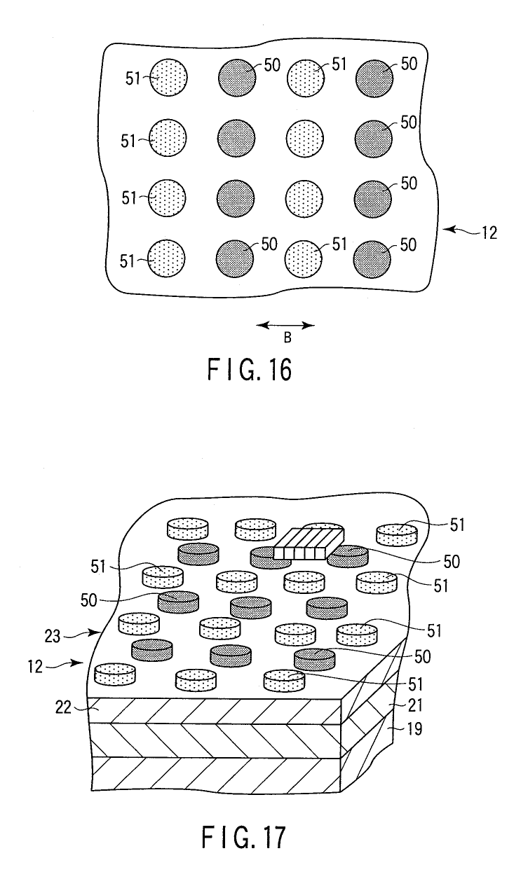

FIGS. 15 and 16 show a recording layer 23 of a magnetic disk 12 of an HDD according to a fourth embodiment. According to the present embodiment, magnetic dots 50 and 51 formed of ferromagnetic materials with different magnetic resonance frequencies are alternately arranged in the circumferential direction or direction of rotation of the magnetic disk 12. In the present embodiment, moreover, the magnetic dots 50 are arranged in lines at predetermined intervals radially relative to the disk 12, and so are the magnetic dots 51.

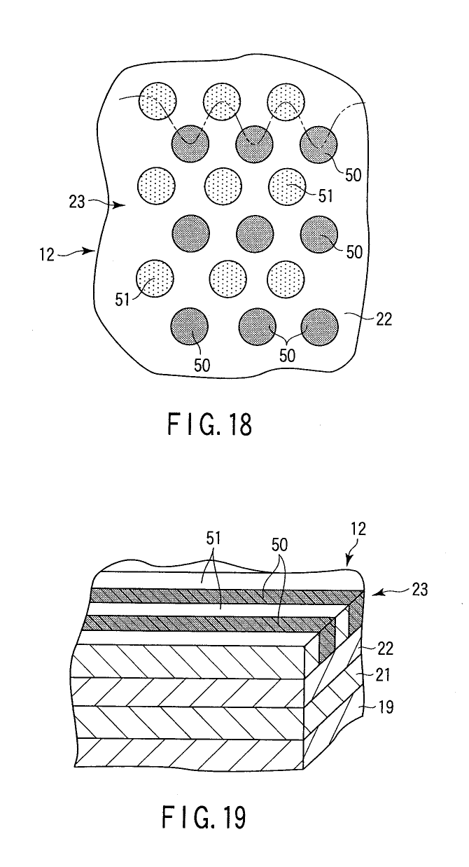

FIGS. 17 and 18 show a recording layer 23 of a magnetic disk 12 of an HDD according to a fifth embodiment. According to the present embodiment, magnetic dots 50 and 51 formed of ferromagnetic materials with different magnetic resonance frequencies are alternately arranged in zigzag in the circumferential direction or direction of rotation of the magnetic disk 12. Thus, in the present embodiment, the magnetic dots 50 are arranged in lines at predetermined intervals circumferentially relative to the disk 12, and so are the magnetic dots 51. The dots 51 in each line are circumferentially offset by a half-pitch relative to the dots 50 in the adjacent lines.

The same functions and effects as those of the first embodiment can be obtained by the use of the magnetic disk 12 according to each of the fourth and fifth embodiments.

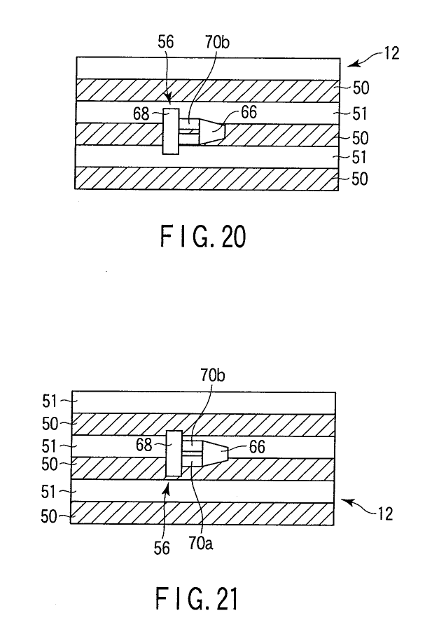

The magnetic material layers in the recording layer of each magnetic disk of the HDD are not limited to the magnetic dots and may be in the form of tracks continuously extending in the circumferential direction. FIGS. 19, 20 and 21 show a recording layer 23 of a magnetic disk 12 of an HDD according to a sixth embodiment. According to the present embodiment, the magnetic disk 12 is formed as a so-called discrete disk, and comprises magnetic tracks 50 and 51 formed of two types of ferromagnetic materials with different magnetic resonance frequencies. These tracks 50 and 51 are alternately concentrically arranged in the radial direction of the disk 12.

According to the HDD comprising the magnetic disk 12 constructed in this manner, it is possible to reduce write errors of adjacent tracks and enlarge radial write margins, thereby improving the recording density.

Other configurations of the HDD according to each of the fourth to sixth embodiments are the same as those of the first embodiment.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, the materials, shapes, sizes, etc., of the constituent elements of the head section may be changed if necessary. Further, the number of magnetic disks and heads used in the magnetic disk drive may be increased as required, and the size of each magnetic disk can be variously selected. The high-frequency oscillatory elements, e.g., spin-torque oscillators, of the recording head are not limited to two in number and may be three or more. In this case, three or more types of magnetic material layers with different magnetic resonance frequencies may be used for the ferromagnetic materials that form the recording layer of the magnetic disk, whereby write margins can be improved. Side shields may be arranged individually on the opposite sides of the main pole with respect to the track.

1.-15. (canceled)

16. A magnetic head comprising:
a main pole configured to apply a perpendicular recording magnetic field to a recording layer of a recording medium;
a return pole opposed to the trailing side of the main pole with a write gap therebetween and configured to reflux magnetic flux from the main pole to form a magnetic circuit in conjunction with the main pole;
a coil configured to excite magnetic flux in the magnetic circuit comprising the main pole and the return pole;
a plurality of high-frequency oscillatory elements individually interposed between the main pole and the return pole, comprising a plurality of magnetic films different in magnetic resonance frequency, and configured to individually apply high-frequency magnetic fields to the recording medium, the high-frequency oscillatory elements being arranged in a line along the track on the main pole; and
an electrical circuit configured to energize the high-frequency oscillatory elements.

17. The magnetic head of claim 16, wherein the high-frequency oscillatory elements comprise a first high-frequency oscillatory element, which comprises an oscillatory layer and a spin injection layer, and a second high-frequency oscillatory element, which comprises an oscillatory layer different from the oscillatory layer of the first high-frequency oscillatory element in magnetic resonance frequency and the spin injection layer shared with the first high-frequency oscillatory element.

18. A disk drive comprising:
a disk-shaped perpendicular magnetic recording medium comprising a recording layer comprising a plurality of magnetic material layers formed of two or more types of ferromagnetic materials different in magnetic resonance frequency and magnetically separated from each other;
a mechanical unit configured to rotate the recording medium; and
a magnetic head comprising a slider having a facing surface configured to face a surface of the recording medium and a head section disposed on one end portion of the slider and configured to process data on the recording medium,
the head section comprising
a main pole configured to apply a perpendicular recording magnetic field to a recording layer of a recording medium,
a return pole opposed to the trailing side of the main pole with a write gap therebetween and configured to reflux magnetic flux from the main pole to form a magnetic circuit in conjunction with the main pole,
a coil configured to excite magnetic flux in the magnetic circuit comprising the main pole and the return pole,
a plurality of high-frequency oscillatory elements individually interposed between the main pole and the return pole, comprising magnetic films different in magnetic resonance frequency, and configured to individually apply high-frequency magnetic fields to the recording medium, the high-frequency oscillatory elements being arranged in a line along the track on the main pole; and
an electrical circuit configured to energize the high-frequency oscillatory elements.

19. The disk drive of claim 18, wherein the high-frequency oscillatory elements comprise a first high-frequency oscillatory element, which comprises an oscillatory layer and a spin injection layer, and a second high-frequency oscillatory element, which comprises an oscillatory layer different from the oscillatory layer of the first high-frequency oscillatory element in magnetic resonance frequency and the spin injection layer shared with the first high-frequency oscillatory element.

20. The disk drive of claim 18, wherein the magnetic material layers are in the form of magnetic dots with different magnetic resonance frequencies.

21. The disk drive of claim 19, wherein the magnetic material layers are in the form of magnetic dots with different magnetic resonance frequencies.

22. The disk drive of claim 20, wherein the magnetic material layers in the form of magnetic dots are alternately arranged in a direction of rotation of the recording medium so as to be magnetically separated from one another.

23. The disk drive of claim 21, wherein the magnetic material layers in the form of magnetic dots are alternately arranged in a direction of rotation of the recording medium so as to be magnetically separated from one another.

24. The disk drive of claim 20, wherein the magnetic dots with the same magnetic resonance frequency are arranged radially relative to the recording medium.

25. The disk drive of claim 21, wherein the magnetic dots with the same magnetic resonance frequency are arranged radially relative to the recording medium.

26. The disk drive of claim 22, wherein the magnetic dots with the same magnetic resonance frequency are arranged radially relative to the recording medium.

27. The disk drive of claim 23, wherein the magnetic dots with the same magnetic resonance frequency are arranged radially relative to the recording medium.

28. The disk drive of claim 20, wherein the magnetic dots are arranged in a zigzag pattern in a direction of rotation of the recording medium.

29. The disk drive of claim 21, wherein the magnetic dots are arranged in a zigzag pattern in a direction of rotation of the recording medium.

30. The disk drive of claim 22, wherein the magnetic dots are arranged in a zigzag pattern in a direction of rotation of the recording medium.

31. The disk drive of claim 23, wherein the magnetic dots are arranged in a zigzag pattern in a direction of rotation of the recording medium.

32. The disk drive of claim 24, wherein the magnetic dots are arranged in a zigzag pattern in a direction of rotation of the recording medium.

33. The disk drive of claim 25, wherein the magnetic dots are arranged in a zigzag pattern in a direction of rotation of the recording medium.

34. The disk drive of claim 26, wherein the magnetic dots are arranged in a zigzag pattern in a direction of rotation of the recording medium.

35. The disk drive of claim 27, wherein the magnetic dots are arranged in a zigzag pattern in a direction of rotation of the recording medium.
